(19) United States
(12) Patent Application Publication
(10) Pub. No.: US 2010/0181252 A1
(43) Pub. Date: Jul. 22, 2010

(54) METHOD AND SYSTEM FOR PURIFYING A LIQUID COMPRISING CRYSTAL INHIBITOR RECOVERY

(76) Inventors: Mateo Jozef Jacques Mayer, Amersfoort (NL); Sybrandus Jacob Metz, Heerenveen (NL); Maarten Markus Nederlor, Veenendaal (NL); Johannes Kuipers, Hantum (NL)

Correspondence Address: MEDLEN & CARROLL, LLP, 101 HOWARD STREET, SUITE 350, SAN FRANCISCO, CA, 94105, US

(21) Appl. No.: 12/449,955

(22) PCT Filed: Mar. 5, 2008
(86) PCT No.: PCT/NL2008/000071

§ 371 Date: Mar. 23, 2010

(30) Foreign Application Priority Data
Mar. 5, 2007 (NL) 1033487
May 10, 2007 (NL) 2000640

(51) Int. Cl. C02F 5/08

(52) U.S. Cl. 210/638; 210/696; 210/668; 210/190

(57) ABSTRACT

The present invention relates to a method for purifying a liquid, comprising the steps of:—supplying a flow of liquid for purifying;—adding a crystal growth inhibitor;—purifying the flow;—separating the flow into a purified flow and a return flow; and—concentrating the crystal growth inhibitor, present in the return flow, in a crystallizer

The present invention relates to a method for purifying a liquid, such as (sea)water, to for instance drinking water.

Known water treatment processes comprise the supply of a water flow to be treated. This supply is generally pretreated, such as for instance in a water softening step. The flow is then purified by a reverse osmosis unit. The purified water is carried further for drinking water purposes and the concentrate is discharged from the unit. Scaling may occur here as a result of, among other factors, an oversaturation of for instance calcium carbonate, wherein nucleation will begin to occur above a critical limit. In order to limit contamination of the unit a quantity of crystal growth inhibitor is added to the incoming flow of water for purifying. This necessary addition of crystal growth inhibitor is discharged by the unit as concentrate. The amount of concentrate which must be discharged in order to prevent contamination is for instance determined by the concentration of calcium and carbonate ions and/or other polyvalent ions such as phosphate, sulphate and magnesium in the feed to the reverse osmosis unit. This will for instance have an adverse effect on the general processing costs and have an environmental impact. In order to limit these effects the process is operated with a relatively low concentration of crystal growth inhibitor. This limits the process efficiency. A possible pretreatment such as a softening step increases investment costs, and both the fixed costs and variable costs increase as the requirement for the purity of the feed to the reverse osmosis unit becomes greater.

The present invention has for its object to provide an improved method for purifying a liquid such as water and to at least partially obviate the above stated drawbacks.

The present invention provides a method as according to claim 1.

Concentrating the flow with the crystal growth inhibitor achieves that the amount of (by-)product to be discharged, and the environmental impact possibly associated therewith, is minimized. It is hereby possible, among other things, to perform the process with a higher concentration of crystal growth inhibitor. This achieves a further limiting of the contamination in the liquid-purifying unit. The costs for the necessary chemicals are also lower. An additional advantage is that the process efficiency is increased and/or maintenance costs are reduced. A further additional advantage is that, by performing the process with a high concentration of crystal growth inhibitor, it is possible to dispense with pretreatment of the liquid flow for purifying, or that such a pretreatment can remain limited. This will also contribute toward more efficient operation of the process due to the reduction in the number of necessary process steps. The crystal growth inhibitors used are preferably polyvalent ions and/or polymers with charged functional groups (sulphonate groups, carboxylate groups, phosphonate groups), wherein the molar mass of the molecules applied as crystal growth inhibitor is preferably greater than 500 g/mol, such as humic acids, oligosaccharides and polysaccharides, polyphosphates. It is noted that the nucleation inhibitor in the method according to the invention must suppress nucleation as much as possible without blocking growth on existing crystal surface, wherein the crystallization takes place substantially in the crystallizer.

In a preferred embodiment according to the invention the concentrated crystal growth inhibitor in the return flow is supplied at least partly to the flow of liquid for purifying.

At least a part of the concentrated flow with crystal growth inhibitor taken up therein achieves that the crystal growth inhibitor can be reused. This has the result that no new crystal growth inhibitor need be added to the flow of liquid for purifying. The process also produces smaller residual flows or waste flows. This reduces the costs of the process. A further additional advantage is that, due to the reuse of the crystal growth inhibitor, the whole process can be performed at a higher concentration of crystal growth inhibitor. Not only does this reduce the contamination in the liquid-purifying unit, but the waste flow is also reduced relative to the amount of purified water. The environmental impact of the crystal growth inhibitor is hereby also reduced, which is for instance relevant in respect of surface water. A further advantage of the reuse of the crystal growth inhibitor, wherein it can be kept substantially wholly within the process, is that other inhibitors are possible, which are at the moment not permissible for environmental reasons. It is for instance possible here to envisage toxic inhibitors for the purpose of reducing so-called biofouling.

In an advantageous embodiment according to the present invention the return flow is circulated in a crystal growth inhibitor-concentrating process loop comprising a nanofiltration unit and a crystallizer.

The nanofiltration unit is fed by the concentrate flow from the purifying process unit. The membranes used herein have a retention for the crystal growth inhibitor higher than 50%, and preferably a retention higher than 95%. The crystallizer in this process loop, which is preferably operated in sluggish flow, decreases the content of polyvalent ions in the concentrate flow by reducing the oversaturation. By feeding the concentrate flow and the outlet of the crystallizer back to the nanofiltration unit, the flow with the crystal growth inhibitor can be concentrated still further. In order to remove crystal growth inhibitor from the waste flow use can optionally be made of spiral-wound polymer nanofiltration membranes, which are characterized by a low investment intensity. At least a part of this flow can be drawn off and fed back to the liquid flow for purifying. The crystallizer can here, be a pellet reactor or a so-called Dynasand filter. A filtration step can therefore also take place in the case of the filter. An additional advantage is that the crystallizer according to a simple design can suffice and that in principle the flow leaving the crystallizer does not have to be filtered before it can be supplied to the nanofiltration installation. The concentration of crystal growth inhibitor in the concentrate of the purifying unit preferably lies between 0.00001, although more particularly 0.0001, and 5 grams/litre, although most preferably between 0.001 and 0.1 gram/litre. The diameter of the crystals produced in the crystallizer preferably lies between 0.1 and 20 mm, although most preferably between 0.5 and 10 mm. A further advantage of the use of the crystallizer is that the polyvalent anions are crystallized in the form of easily handled particles which can for instance be applied as fertilizer with a controlled release. This can be realized by choosing the correct concentration of inter alia the crystal growth inhibitor. The purity of the crystals can be controlled here by inter alia the choice of a crystal growth inhibitor and the concentration thereof. Contaminants such as organic components or metal ions are preferably incorporated in the crystals using the correct choice of a so-called smart crystal growth inhibitor or, conversely, the incorporation of such contaminants is prevented, for instance if the outgoing flow from the crystallizer is going to be used as fertilizer. Such a smart crystal growth inhibitor can be the already applied crystal growth inhibitor or an extra additive. The flow of water for purifying is preferably pretreated. However, because the process can be carried out at a higher concentration of crystal growth inhibitor due to the recovery of crystal growth inhibitor, pretreatment is not necessary in all cases.

In a preferred embodiment according to the present invention the purification of the flow of liquid for purifying is performed in a reverse osmosis unit.

Performing purification in a reverse osmosis unit achieves that the invention can also be applied at existing plants, wherein only limited modifications need be made to the process.

In an alternative preferred embodiment according to the present invention the flow of liquid for purifying is purified in a nanofiltration membrane unit.

By performing the purification of the liquid flow in the filtration unit the reverse osmosis unit can be omitted. This limits the number of processing steps and process installations. This further limits process investments.

In an alternative preferred embodiment according to the present invention the return flow is carried to an ion exchanger in order to recover the crystal growth inhibitor.

Through the use of the iron exchanger, preferably placed after the crystallizer, it is possible to dispense with the nanofiltration unit. Also possible however are a combination of process steps for concentrating the crystal growth inhibitor and optionally at least partial feeding back thereof to the flow of liquid for purifying.

The present invention further relates to a system for purifying water with which advantages similar to those of the method can be achieved.

Further advantages, features and details of the invention are elucidated on the basis of preferred embodiments thereof, wherein reference is made to the accompanying drawings, in which:

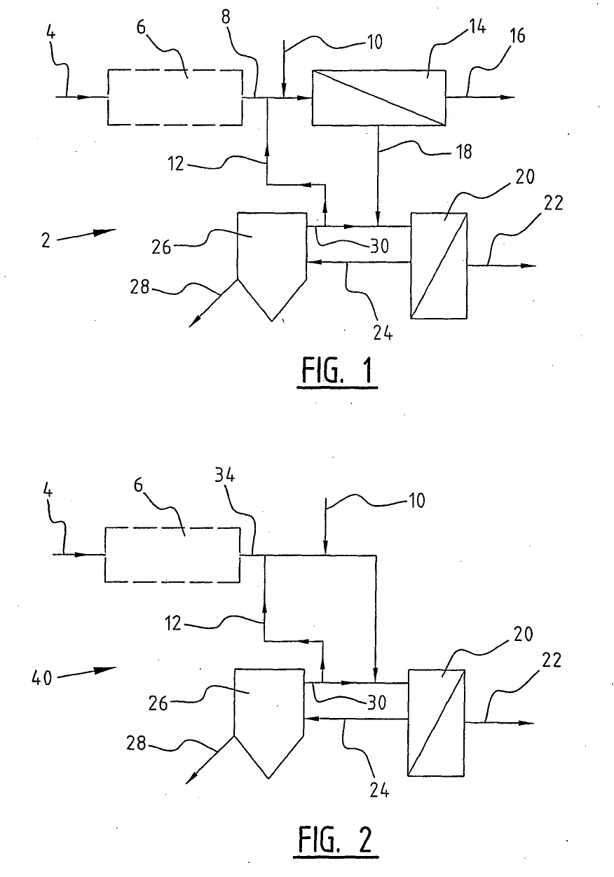

FIG. 1 shows a schematic representation of a method according to the invention;

FIG. 2 shows an alternative embodiment according to the invention;

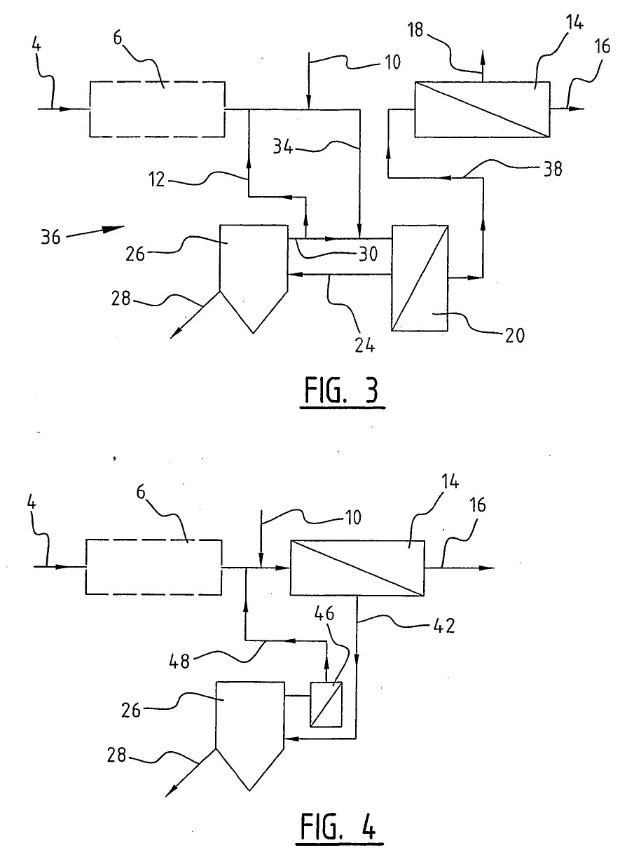

FIG. 3 shows a further alternative embodiment according to the invention; and

FIG. 4 shows a further alternative embodiment according to the invention.

The process 2 for purifying a flow of water for the purpose of drinking water production (FIG. 1) comprises of supplying the flow of water 4 which is added to a pretreatment unit 6. This unit 6 can provide a chemical pretreatment. As a result of the processing at a higher concentration of crystal growth inhibitor, the pretreatment 6 can however optionally be omitted. The optionally pretreated flow of water 8 for purifying is carried to purifying unit 14 in the form of a reverse osmosis unit. Crystal growth inhibitor can be added to water flow 8 for purifying. This crystal growth inhibitor can come from a separate output 10 and/or from a feed 12 from a return flow. The outlet of the reverse osmosis unit 14 comprises purified drinking water 16. The concentrate 18 of unit 14, with the residual substances taken up therein, is carried to a nanofiltration unit 20. Permeate 22 from this unit 20, which is free of particles and is not saturated with salts, can for instance be used as process water for another process. This unit 20 consists for instance of a relatively open, spiral-wound polymer membrane characterized by a high throughput, which is preferably clearly higher than 10 litres/(m² hour) at a relatively low transmembrane pressure, and a higher retention of the crystal growth inhibitor. The permeate 22 from unit 20 is hereby substantially free of crystal growth inhibitor and can therefore be readily discharged or serve as fodder. The concentrate 24 from nanofiltration unit 20 has a high concentration of crystal growth inhibitor and will also be oversaturated with polyvalent ions such as calcium carbonate. The flow 24 is fed to crystallizer 26. Crystallizer 26 is, preferably embodied as a so-called fluidized bed reactor (pellet reactor) or as a packed bed reactor. These are substantially plug flow crystallizers. Such crystallizers enhance the crystallization of calcium carbonate, thereby increasing the productivity. As a result of the crystal growth inhibitor that is present the oversaturation of the polyvalent ions is deposited on the already present crystal surface in crystallizer 26. The greater part of the polyvalent ions will leave crystallizer 26 as solid flow 28. The diameter of the crystals in this flow 28 are preferably between 0.5 and 10 millimetres so as to enable use of this solid as for instance fertilizer. The crystal-free product leaving the crystallizer in flow 30 is fed back to nanofiltration unit 20. Return flow 30 is not all that oversaturated. The concentration factor of the nanofiltration unit is set such that the oversaturation does not exceed the critical oversaturation at which primary nucleation occurs. Due to the high concentration of crystal growth inhibitor in the concentrate loop, the critical oversaturation for primary nucleation of the polyvalent ions is considerably higher than in the concentrate of the reverse osmosis installation that is generally used. Due to the suppression of nucleation, deposition of the oversaturation in the concentrate flow takes place on existing crystal surface. A part of the outlet flow 30 from crystallizer 26 is drawn off and fed back via feed 12 to the water flow 8 for purifying. In this way the crystal growth inhibitor is reused and is retained within the general purification process. This means that there will be substantially no consumption of crystal growth inhibitor, and crystal growth inhibitor thus need not be added via separate inlet 10 once the process has started up.

In a variant 32 of the process (FIG. 2) the supply of process water 34 for purifying is not fed to a reverse osmosis unit but directly to nanofiltration unit 20. Permeate 22 is then usable as drinking water. A process unit is hereby omitted. The other process units must of course be adjusted to the changed process flows.

An alternative variant 36 (FIG. 3) supplies the flow of process water 34 for purifying to nanofiltration unit 20. Permeate flow 38 from this unit 20 is carried to the inlet of reverse osmosis unit 14. Unit 14 produces the drinking water 16 and further comprises a residue flow 18. The operation of this variant 36 is otherwise the same as that as shown in FIG. 1.

In a further alternative variant 40 (FIG. 4) the flow of concentrate 42 from reverse osmosis unit 14 is carried directly to crystallizer 26. The output of crystallizer 26 in flow 44 is carried to an ion exchanger 46. The output of this ion exchanger 46 is fed as flow 48 back to the process flow 8 for purifying. Flow 48 comprises the high concentration of crystal growth inhibitor, whereby the crystal growth inhibitor is retained in the process with, among others, the above described advantages.

The present invention is by no means limited to the above described preferred embodiments. The rights sought are defined by the following claims, within the scope of which many modifications can be envisaged. It is thus possible for instance to use the described process in respect of both the method and the system in for instance wastewater purification processes. It is possible here, in similar manner as described above, to keep the polyvalent ions in the process by causing them to deposit selectively, such as for instance in the form of struvite. Is also possible to use residual flows as alternative energy source by making use for instance of the salts that are present. Owing to the reduced contamination in the reverse osmosis unit it is also possible to allow the purification to take place at an increased pressure. The efficiency of the purification process can hereby optionally be further increased. Another option is to embody the crystallizer as a train of crystallizers so that it is possible to suffice with smaller dimensions and/or these can be aimed specifically at determined residual flows from the crystallizers. The outgoing concentrate from the crystallizers can optionally be separated. In the case of a supplied water flow with pesticides, these latter are filtered in the nanofiltration step. In the case of hormones the hormone concentrations are increased by the presence of the concentration loop formed by the crystallizer and the nanofiltration unit, so that they can be removed more easily. It is also possible to give the return flow an ultrasonic treatment, for instance instead of a treatment in a crystallizer. An explosion in the number of particles will occur here. These small particles do not disrupt the process. The ultrasonic treatment is optionally combined with a settler and/or filter in order to limit environmental impact due to discharge of the small particles.

1. Method for purifying a liquid, comprising the steps of:
a) supplying a flow of liquid for purifying;
b) adding a crystal growth inhibitor;
c) purifying the flow;
d) separating the flow into a purified flow and a return flow; and
e) concentrating the crystal growth inhibitor, present in the return flow, in a crystallizer.

2. Method as claimed in claim 1, wherein at least a part of the concentrated crystal growth inhibitor from the return flow is added to the flow of liquid for purifying.

3. Method as claimed in claim 2, wherein the return flow is circulated in a crystal growth inhibitor-concentrating process loop comprising a nanofiltration unit and the crystallizer.

4. Method as claimed in claim 3, wherein the crystal growth inhibitor-recovering process loop is operated with a concentration of crystal growth inhibitor in the range of 0.00001 g/l to 5 g/l.

5. Method as claimed in claim 1, wherein contaminants are selectively taken up by the crystal growth inhibitor.

6. Method as claimed in claim 1, wherein the flow of water for purifying is pretreated.

7. Method as claimed in claim 1, wherein the purification of the flow of liquid for purifying is performed in a reverse osmosis unit.

8. Method as claimed in claim 1, wherein the purification of the flow of liquid for purifying is performed in a nanofiltration membrane unit.

9. Method as claimed in claim 1, wherein the return flow is filtered in a nanofiltration unit and separated into a waste flow and a concentrated flow with crystal growth inhibitor.

10. Method as claimed in claim 1, wherein the return flow is fed to an ion exchanger for the purpose of recovering the crystal growth inhibitor.

11. System for purifying water, comprising:
a) a purifying unit for purifying the flow of liquid, wherein a crystal growth inhibitor is added to the flow for purifying; and
b) a crystallizer for concentrating the flow with the crystal growth inhibitor from the return flow of the purifying unit.

12. System as claimed in claim 11, provided with a device for adding at least a part of the concentrated flow with the crystal growth inhibitor to the flow of water for purifying.
